(19) United States
(12) Patent Application Publication
(10) Pub. No.: US 2012/0042351 A1
(43) Pub. Date: Feb. 16, 2012

(54) BROADCAST SYSTEM FOR SHARING MEDIA CONTENT AND METHOD THEREOF

(75) Inventors: YAN-ZHI WANG, Shanghai (CN); JUAN CAO, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 12/954,909

(22) Filed: Nov. 29, 2010

(30) Foreign Application Priority Data
Aug. 13, 2010 (CN) 201010253229.8

(51) Int. Cl. H04N 7/173

(52) U.S. Cl. 725/116

(57) ABSTRACT

A broadcast system for media content sharing includes a receiver, a verification module, a communication module, a storage, a processor and a transmitter. The receiver receives a configuration information of a media program from a first client. The verification module verifies the configuration information of the media program. The communication module communicates with a second client to confirm a transmission time period when the verification performed by the verification module is passed. The processor transforms the media program as a data stream and stores the data stream in the storage. The transmitter transmits the data stream to the second client.

### BACKGROUND

1. Technical Field

The present disclosure relates to a broadcast server, and more particularly to a broadcast server allowing clients to share media content.

2. Description of Related Art

Digital broadcast network typically only support one way communications. User clients, such as a set-top box, can only communicate from the content provider to the client to download programs. As a result, clients can only watch the media programs provided by the content provider but have no options to select programs they want. In addition, the client also has no authority to share programs they ordered to other clients. Therefore, a need exists in the industry to overcome the described limitations.

### BRIEF DESCRIPTION OF THE DRAWINGS

FIG. 1 is the block diagram of one embodiment of a broadcast system of the present disclosure.

FIG. 2 is a flowchart of one embodiment of a broadcast method for sharing media content of the present disclosure.

### DETAILED DESCRIPTION

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used herein, refers to logic embodied in hardware or firmware, or to a collection of software instructions, written in a programming language, such as, for example, Java, C, or assembly. One or more software instructions in the unit may be integrated in firmware, such as an EPROM. It will be appreciated that module may comprise connected logic units, such as gates and flip-flops, and may comprise programmable units, such as programmable gate arrays or processors. The unit described herein may be implemented as either software and/or hardware unit and may be stored in any type of computer-readable medium or other computer storage device.

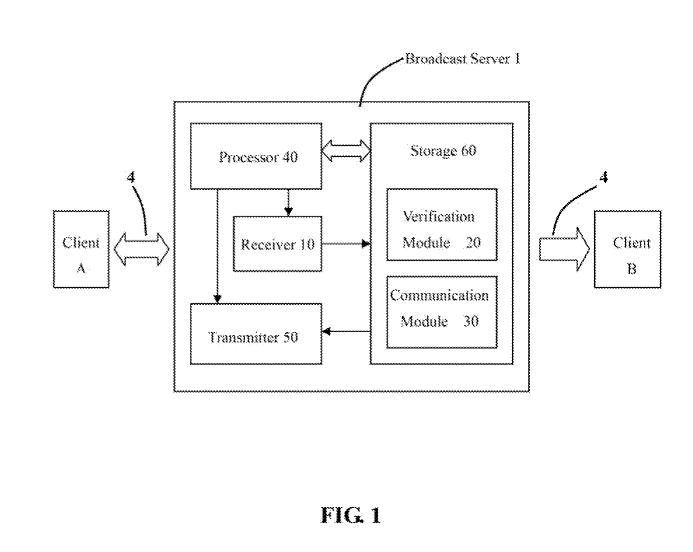

FIG. 1 is the block diagram of one embodiment of a broadcast system of the present disclosure. The broadcast system includes a broadcast server 1, a client A and a client B. The broadcast server 1 includes a receiver 10, a verification module 20, a communication module 30, a processor 40, a transmitter 50 and a storage 60. In one embodiment, the verification module 20 and the communication module 30 are stored in the storage 60. The processor 40 controls the verification module 20 and the communication module 30 to execute its functions described below. The broadcast server 1 transmits media content ordered by the client A to the client B through a digital broadcast network 4. Using the broadcast server 1, the client B is capable of watching media programs ordered by the client terminal A for media content sharing purposes. In one embodiment, the client A is a dual communication set-top box for both downloading and uploading data. The client A has authorities to communicate with a digital TV broadcaster, such as an internet content provider, a cable line content provider or a digital Television Terrestrial broadcaster, and uploads media content to the digital TV broadcaster. In other words, the client A is a set-top box with both download/upload ability to communicate with the content provider. The client B is a one way communication set-top box, which only has authorities to download data from the content provider and receives commands from the content provider. The storage may be a hard disk drive, for example.

The broadcast server 1 is generally controlled and coordinated by an operating system, such as UNIX, Linux, Windows, Mac OS, an embedded operating, or any other compatible system. Alternatively, the broadcast server 1 may be controlled by a proprietary operating system. Typical operating systems control and schedule computer processes for execution, perform memory management, provide file system, networking, and I/O services, and provide a user interface, such as a graphical user interface (GUI), among other tasks.

The verification module 20 verifies the configuration information of the client A. The verification module 20 verifies whether the user code of client B is valid. In one embodiment, the user code is provided by the content provider, and is defined to be a unique identification code for each verified client terminal, such as an email address or an user name with password. If the web-addresses of media programs are provided by the client B, the verification module 20 further verifies whether the corresponding program can be downloaded through the address link. In one embodiment, the web-addresses of media programs are internet addresses which are accessible links of the media programs the content provider provided for authority terminal. The verification unit 20 also verifies whether the media program provided by the client A can be transformed into a data stream complying with a media format supported by the client B. In one embodiment, the media format is format supported by MPEG, RMVB, Real Player and DVIX formats. If above verifications are all passed, the verification module 20 sends a pass message to notify the client A. If one of above verifications is failed, the verification module 20 sends a failure message to notify the client A and deletes the corresponding configuration information.

The communication module 30 communicates with the client B to confirm a time schedule of the media program that is being broadcasted/transmitted. The communication module 30 informs the information of a corresponding media program to the client B. If the client agrees to receive the media program, the broadcast server 1 provides at least one available time period to the client B for downloading the media content. The client B choices a time period from the at least one time period provided by the broadcast server 1. The broadcast server 1 transmits the media program to the client B at the chosen time period.

If the client disagrees to receive the media program or does not response to the confirmation request from the communication module 30, the broadcast server 1 deletes the media program content. In one embodiment, the information of the media program includes producer information and introduction of the media program.

The processor 40 transforms the media program as a data stream complying with media format supported by the client B. The processor 40 further stores the data stream in the storage 60. The processor 40 also determines whether the time period of transmitting the media program is reached. If the time period is reached, the transmitter 50 transmits the media program to the client B.

The transmitter 50 transmits the data stream of the media program to the client B, and sends a complete message to the client A when the transmission of the media program is completed.

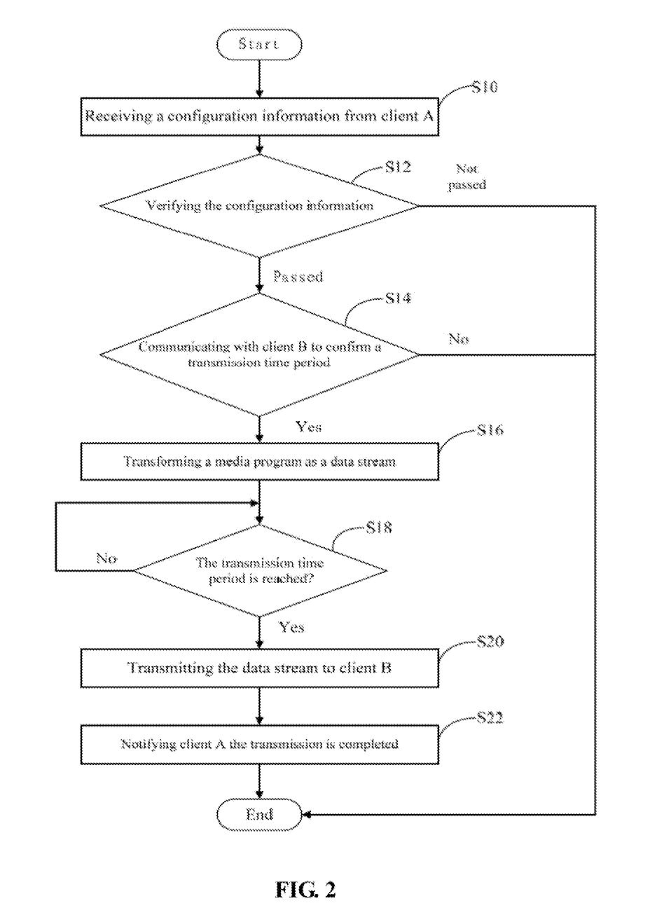

FIG. 2 is a flowchart of one embodiment of a broadcast method for sharing media content of the present disclosure. In the block S10, the receiver 10 receives the configuration information of a media program from the client A. In one embodiment, the configuration information includes a user code and a media program list of the client A. The program list contains information about what media content is ordered by the client A, the web address of the ordered content or introduction of the media content. The user code of the client A or the client B is an identification code provided by the content provider. Specifically, the content provider provides an unique identification code to each verified client terminal, such as an email address or an user name with password. It is so called user code herein. The verification of the clients can be executed by sending the user code to the content provider through web page, phone confirmation or Multimedia Messaging Service (MMS).

In the block S12, the verification module 20 verifies the configuration information of a media program from the client A. If the verification is passed, the S14 step of the flow chart is executed.

In the block 14, the communication module 30 communicates with the client B to confirm the transmission time period of the media program. If the client B confirms the transmission time period, the S16 step of the flow chart is executed.

In the block S16, the processor 40 transforms the media program as a data stream complying with media format supported by the client B. The processor 40 further stores the data stream in the storage 60.

In the block S18, the processor 40 determines whether the transmission time period is reached. If it's not reached, the process unit 40 re-executes the block S18.

In the block S20, the transmitter 50 transmits the data stream of the media program to the client B.

In the block S22, the transmitter 50 sends a complete message to the client A when the transmission of the data stream is completed.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A broadcast system comprising a storage, comprising:
a receiver that receives a configuration information of a media program from a first client;
a verification module that verifies the configuration information of the media program;
a communication module that communicates with a second client to confirm a transmission time period when the verification performed by the verification module is passed;
a processor that transforms the media program as a data stream and stores the data stream in the storage; and
a transmitter that transmits the data stream to the second client.

2. The broadcast system of claim 1 wherein the processor determines whether the transmission time period is reached and sends a complete message to the first client.

3. The broadcast system of the claim 1, wherein the first client is a dual communication set-top box with download and upload ability to communicate with a content provider, and the second client is a one way communication set-top box that only has authorities to download data from the content provider and receives commands from the content provider and the first client.

4. The broadcast system of the claim 1, wherein the first client has authorities to download and upload communicate with a digital broadcaster.

5. The broadcast system of the claim 4, wherein the digital broadcaster is selected from the group of an internet content provider, a cable line content provider and a digital Television Terrestrial broadcaster.

6. A broadcast method for sharing media content, the method comprising:
receiving a configuration information of a media program of a first client;
verifying the configuration information of the media program;
communicating with a send client to confirm a transmission time period of the media program;
transforming the media program as a data stream and storing the data stream in a storage when the verification of the configuration information is passed; and
transmitting the data stream to the second client.

7. The broadcast method of claim 6, further comprising:
determining whether the transmission time period is reached; and
sending a complete message to the first client.

8. The broadcast method of claim 6, wherein the first client is a dual communication set-top box with both download/upload ability to communicate with a content provider and the second client is an one way communication set-top box that only has authorities to download data from the content provider and receives commands from the content provider and the first client.

9. The broadcast method of claim 8, wherein the first client has authorities to download and upload communicate with a digital broadcaster.

10. The broadcast method of claim 9, wherein the digital broadcaster is selected from the group of an internet content provider, a cable line content provider and a digital Television Terrestrial broadcaster.
